(19) United States
(12) Patent Application Publication
(10) Pub. No.: US 2015/0116882 A1
(43) Pub. Date: Apr. 30, 2015

(54) APPARATUS AND METHOD FOR TIME-DELAYED THERMAL OVERLOAD PROTECTION

(71) Applicant: ANALOG DEVICES, INC., Norwood, MA (US)

(72) Inventor: Derek F. Bowers, Los Altos Hills, CA (US)

(73) Assignee: ANALOG DEVICES, INC., Norwood, MA (US)

(21) Appl. No.: 14/069,175

(22) Filed: Oct. 31, 2013

(51) Int. Cl. H02H 3/04; H02H 3/027

(52) U.S. Cl. CPC H02H 3/04; H02H 3/027
USPC 361/103

(57) ABSTRACT

Apparatus and methods for time-delayed thermal overload protection are provided. In one aspect, an integrated circuit includes a primary circuit disposed in a primary circuit region on a substrate, and a thermal protection circuit disposed in a thermal protection circuit region on the substrate and in thermal communication with the primary circuit. The thermal protection circuit includes a temperature sensing circuit configured to sense a temperature of the thermal protection circuit region and to activate a temperature warning signal when the temperature exceeds a temperature threshold level. The thermal protection circuit additionally includes a time delay circuit configured to activate a shut off signal to disable at least a portion of the primary circuit when the temperature warning signal is active for a duration exceeding a time delay.

### FIELD

The disclosed technology relates to electronics, and more particularly, to methods and structures to protect integrated circuits from being damaged by thermal overload.

### BACKGROUND

Electronic components such as integrated circuit devices may be subject to thermal overload during operation, which can arise from, for example, Joule heating associated with the devices' current dissipation. Thermal overload can result in permanent damage to the integrated circuit devices.

To help prevent thermal overload, a thermal protection circuit can be used to shut down the integrated circuit devices in response to a thermal overload signal indicating that a detected temperature exceeds a certain threshold temperature.

### SUMMARY

In one aspect, a thermal overload-protected integrated circuit comprises a primary circuit disposed in a primary circuit region on a substrate and a thermal protection circuit disposed in a thermal protection circuit region on the substrate, wherein the primary circuit and the thermal protection circuit are in thermal communication. The thermal protection circuit of the integrated circuit comprises a temperature sensing circuit configured to sense a temperature of the thermal protection circuit region and to activate a temperature warning signal when the temperature exceeds a temperature threshold level. The thermal protection circuit additionally comprises a time delay circuit configured to activate a shut off signal to disable at least a portion of the primary circuit when the temperature warning signal is active for a duration exceeding a time delay.

In another aspect, a method of protecting a monolithically integrated circuit from thermal overload comprises sensing a temperature of a thermal protection circuit region using a sensing circuit disposed in the thermal protection circuit region. The method additionally comprises activating a temperature warning signal using the sensing circuit when the temperature exceeds a temperature threshold level. The method additionally comprises activating a shut off signal using a time delay circuit in response to the temperature warning signal being active for a duration exceeding a time delay. The method further comprises disabling a primary circuit disposed in a primary circuit region in response to activation of the shut off signal.

### BRIEF DESCRIPTION OF THE DRAWINGS

FIG. 1 is a schematic depiction of a thermal overload-protected integrated circuit comprising a thermal protection circuit according to one embodiment.

FIG. 2 is a schematic depiction of a thermal protection circuit region according to one embodiment.

FIG. 3 is a schematic cross-sectional view of a thermal overload-protected integrated circuit comprising a thermal protection circuit according to one embodiment.

FIG. 4A is a circuit diagram of a thermal overload protection circuit according to one embodiment.

FIG. 4B is a circuit diagram of a thermal overload protection circuit according to another embodiment.

### DETAILED DESCRIPTION OF THE PREFERRED EMBODIMENT

The following detailed description of embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Monolithic integrated circuits (ICs) can propagate surface thermal waves when subjected to a transient increase in power dissipation. Absent a protection scheme, thermal overload can cause IC damage.

An IC can use a temperature sensor to gauge the temperature of a primary circuit, such as an amplifier. Since damage associated with high temperature conditions can occur relatively quickly, the temperature sensor and the primary circuit can be fabricated on the same die to enhance detection.

Temperature sensing in ICs fabricated using silicon-on-insulator (SOI) technology poses additional challenges. SOI technology is increasingly being used for certain applications, including, for example, high voltage applications and/or low capacitance applications. An SOI substrate includes an embedded dielectric film which separates a support substrate from a SOI layer. Active devices such as transistors can be fabricated in the SOI layer, which reduces parasitic capacitances of the active devices.

Thermal resistance relates to a measurement of a temperature difference by which an object or material resists a heat flow. Since SOI substrates include embedded dielectric films, a vertical thermal resistance in a direction perpendicular to the dielectric film is typically higher compared to a lateral thermal resistance. This relative asymmetry in thermal resistance is in contrast to non-SOI substrates, in which vertical and lateral thermal resistances can be substantially similar.

For a similar amount of power dissipation, devices fabricated on SOI substrates can heat up faster and/or to a higher temperature compared to devices fabricated on non-SOI substrates. This can be caused, for example, by enhanced confinement of generated heat within the SOI layer, which can result in enhanced transfer of heat pulses within the SOI layer to surrounding regions. The enhanced heat transfer can result in a much faster temperature response by a temperature sensor.

When the temperature sensor detects a temperature greater than a threshold temperature, the temperature sensor can shut down a primary circuit to prevent damage. For example, in certain configurations the primary circuit includes an amplifier, and the temperature sensor can disable an output stage of the amplifier when the detected temperature exceeds the threshold temperature.

In certain configurations, a heat pulse can reach an integrated temperature sensor relatively quickly, which in turn can result in a relatively fast shut-down of the primary circuit. On the one hand, the faster temperature response can be advantageous in certain configurations from the standpoint of faster detection. On the other hand, too fast of a temperature response can increase the likelihood of false activation of the temperature sensor. For example, an IC can include an amplifier, and a surface thermal wave can propagate when a relatively fast transient input signal is applied to the amplifier's inputs, thereby triggering the temperature sensor to falsely activate.

Accordingly, there is a need to discriminate the detected temperature signals, such that a primary circuit is prevented from being shutdown prematurely and/or in response to certain signals that may be non-damaging. For example, it may be desirable to avoid activation of a shutdown signal in response to certain detected transient temperature signals, for example, those lasting for a shorter duration than a certain time period.

Therefore, there is a need for a thermal overload-protected integrated circuit including a thermal protection circuit which can activate a shutdown signal to a primary circuit based on the characteristics of a temperature warning signal. For example, in certain implementations, a thermal protection circuit includes a temperature sensing circuit that can sense a temperature and activate a temperature warning signal when the temperature exceeds a temperature threshold level, and a time delay circuit that can activate a shut off signal when the temperature warning signal is active for a duration exceeding a time delay. The shut off signal can be used to disable at least a portion of the primary circuit.

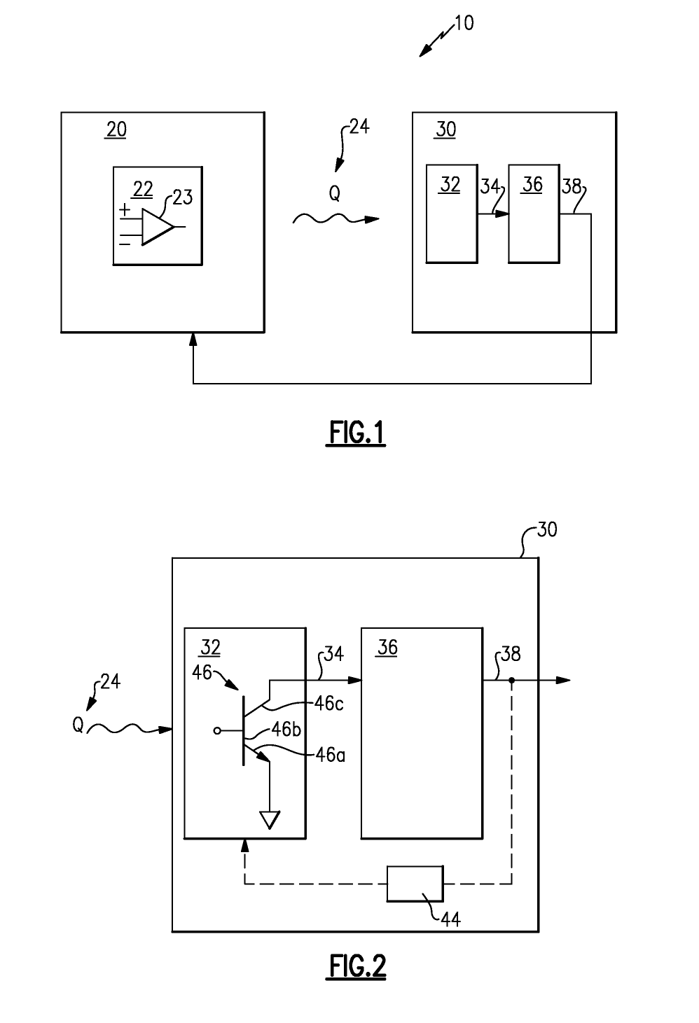

FIG. 1 is a schematic depiction of a thermal overload-protected integrated circuit 10 comprising a thermal protection circuit according to one embodiment. The thermal overload-protected integrated circuit 10 includes a substrate on which a primary circuit region 20 and a thermal protection circuit region 30 are disposed. The primary circuit region 20 and the thermal protection circuit region 30 are disposed on a single or common substrate and are in thermal communication with each other.

The substrate can include any suitable semiconductor substrate on which electronic circuits can be monolithically integrated. In one embodiment, the substrate comprises a silicon-on-insulator (SOI) substrate. However, other configurations are possible.

In the illustrated configuration, the integrated circuit 10 includes a primary circuit 22 disposed in the primary circuit region 20. The primary circuit 22 can include any suitable integrated circuit device that can be damaged due to thermal overload, including, for example, an amplifier 23. However, other configurations are possible, including, for example, implementations in which the primary circuit 22 includes power circuitry, such as a regulator.

As shown in FIG. 1, the illustrated integrated circuit 10 additionally includes a temperature sensing circuit 32 disposed in the thermal protection circuit region 30. The primary circuit region 20 and the thermal protection circuit region 30 are disposed on a single substrate such that the primary circuit 22 and the thermal protection circuit 32 are in thermal communication with each other. In operation, the temperature sensing circuit 32 is configured sense a temperature of the thermal protection circuit region 30, which may change upon receiving heat 24 generated by the primary circuit 22. The heat 24 can be generated from a variety of sources, such as when the primary circuit 22 receives a fast transient input signal or is powered up, during which the power dissipated in the primary circuit 22 is converted to heat by Joule heating of semiconducting and metallic components of the primary circuit 22. Upon sensing a temperature exceeding a threshold temperature, the temperature sensing circuit 32 is configured to activate a temperature warning signal 34.

In some embodiments, the thermal protection circuit 32 can sense the temperature directly based on a temperature change resulting from heat transferred from the primary circuit 22, without receiving additional electrical signals. In other embodiments, the temperature sensing circuit 32 is in electrical communication with the primary circuit 22 such that it is configured to sense the temperature indirectly based on an electrical signal (for example, a current signal and/or a voltage signal) received from the primary circuit 22. For example, the primary circuit 22 can provide the temperature sensing circuit 22 with a signal indicative of an amount of the primary circuit's dynamic power dissipation, which can be indicative of the temperature of the primary circuit region 20. In another embodiment, the temperature sensing circuit 32 can sense the temperature based on a combination of the temperature change resulting from the heat transfer and on an electrical signals from the primary circuit 22.

The integrated circuit 10 additionally includes a time delay circuit 36 disposed in the thermal protection circuit region 30 and electrically connected to the thermal protection circuit 32. The time delay circuit 36 is configured to receive the temperature warning signal 34 from the thermal protection circuit 32 and activate a shut off signal 38 when the temperature warning signal 34 exceeding a threshold temperature has been active for a duration exceeding a threshold time duration or time delay. In certain configurations, the time delay circuit 36 comprises an analog circuit. For example, the time delay can be based on a resistor-capacitor (RC) time constant of the analog circuit. However, other configurations are possible, such as implementations in which the time delay circuit 36 is implemented using a digital circuit, or a combination of analog and digital circuits.

As shown in FIG. 1, the primary circuit 22 receives the shut-off signal 38 from the time delay circuit 36. The shut-off signal 38 can be used to disable at least a portion of the primary circuit 22 to prevent damage to the primary circuit 22. In one embodiment, the primary circuit 22 comprises an amplifier, and the shut-off signal 38 can be used to disable at least a portion of the amplifier, such as by decreasing or turning off the amplifier's bias current. In another embodiment, the primary circuit 22 comprises an amplifier, and the shut-off signal 38 can be used to disable the amplifier by reducing or blocking an input voltage to the amplifier, such as by opening one or more switches used to provide the input voltage to the amplifier's differential pair.

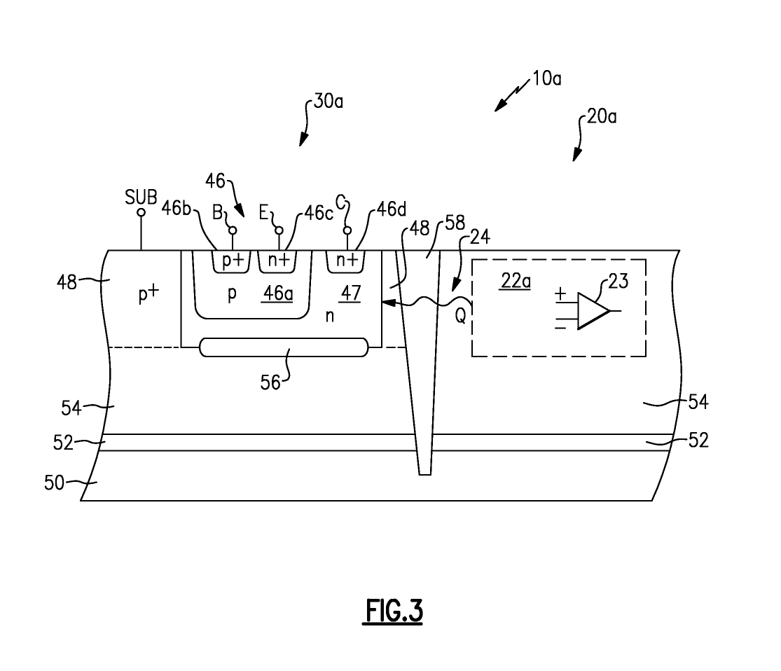

FIG. 2 is a schematic depiction of a thermal protection circuit region 30 of a thermal overload-protected integrated circuit according to one embodiment. Similar to FIG. 1, the thermal protection circuit region 30 is configured to receive heat 24 from a nearby region such as a primary circuit region and comprises a temperature sensing circuit 32 in thermal communication with a primary circuit, and a time delay circuit 36 connected to the temperature sensing circuit 32. Similar to FIG. 1, the time delay circuit 36 is configured to activate a temperature warning signal 34 upon sensing a temperature exceeding a threshold temperature level.

In one embodiment, the thermal protection circuit region 30 is configured to receive the heat 24 from a primary circuit region that is separated from the thermal protection circuit region 30 by a distance in the range of about 1 μm and about 500 μm. However, other distances are possible.

In one embodiment, the temperature sensing circuit 32 comprises a bipolar junction transistor (BJT) 46. The BJT 46 comprises an emitter 46a, a base 46b, and a collector 46c. In certain implementations, without being bound by any theory, a collector current I_{C} can be expressed as a function of emitter-base voltage V_{BE} approximately as:

$${I}_{C} = {I}_{S} exp [ \frac{{qV}_{BE}}{kT} ] , \qquad [ 1 ]$$

where k is Boltzmann's Constant, T is the absolute temperature, and q is the charge of an electron. The prefactor of Equation [1] Iₛ depends on the geometry and the temperature of the transistor, and can be expressed approximately in some embodiments as:

$${I}_{S} = {KT}^{\frac{3}{η}} exp [ \frac{{qV}_{G}}{η kT} ] , \qquad [ 2 ]$$

where K is a constant related to an emitter area, a base region width and a base doping concentration, η is a non-ideality factor, and V_{G} is a bandgap of the semiconductor material of the BJT 46. The temperature dependence of I_{S} can be attributed to the temperature dependences of the diffusion constant for electrons Dₙ and the intrinsic carrier concentration nᵢ.

In certain implementations, the temperature warning signal 34 comprises the collector current I_{C} or a signal indicative of the collector current I_{C}, such as a mirror of the collector current I_{C}. In other embodiments, the temperature warning signal 34 comprises the base-emitter voltage V_{BE} or a signal indicative thereof. Accordingly, in certain implementations, the temperature warning signal 34 can be based on a voltage, a current, or a combination thereof. Although FIG. 2 illustrates the BJT 46 in an NPN configuration, in certain implementations a PNP bipolar transistor can be used.

In some configurations, the temperature warning signal 34 can correspond to a signal generated by more than one BJT 46. For example, if first and second nominally identical bipolar junction transistors BJT₁ and BJT₂ are biased to have first and second collector currents I₁ and I₂ whose ratio I₁/I₂=n is a constant, then the difference in the V_{BE}'s of transistors can be expressed as:

$$Δ {V}_{BE} = {V}_{BE 1} - {V}_{BE 2} = \frac{kT}{q} ln n , \qquad [ 3 ]$$

where n is a constant. In such configurations, absolute temperature T can be measured without being affected by the temperature sensitive I_{S}.

Although various embodiments of temperature sensing circuits including bipolar transistors have been described above, other configurations of temperature sensing circuits are possible, including, for example, configurations using temperature sensing diodes and/or field-effect transistors (FET)s. For example a temperature sensor can include active devices, such as bipolar junction transistors, field-effect transistors, and/or diodes, as well passive devices, such as resistors, capacitors, and/or inductors.

Still referring to FIG. 2, the thermal protection circuit region 30 additionally includes a time delay circuit 36, which is electrically connected to the temperature sensing circuit 32. The time delay circuit 36 receives the temperature warning signal 34, and can activate a shut off signal 38 when the temperature warning signal 34 is active for a duration exceeding a threshold time duration.

As discussed above, the temperature warning signal 34 generated by the temperature sensing circuit 32 can be a current signal and/or a voltage signal. In some embodiments, the time delay circuit 36 can activate the shut off signal 38 in response to a temperature warning signal 34 that exceeds a threshold temperature level. For example, the time delay circuit 36 can be configured to activate the shut off signal 38 in response to a collector current I_{C} exceeding a threshold I_{C} value or in response to a V_{BE} exceeding a threshold V_{BE} value. However, other configurations are possible, such as configurations in which the temperature warning signal 34 is generated without the use of bipolar transistors.

As discussed above, it may be advantageous to configure the time delay circuit 36 such that the activation of the shut off signal 38 is delayed by a threshold time duration or time delay τ_{DELAY} even when the temperature warning signal 34 exceeds the various threshold values discussed above. In this connection, in some embodiments, the time delay circuit 36 is configured to activate a shut off signal 38 in response to a temperature warning signal 34 that exceeds a threshold temperature level for a duration exceeding the τ_{DELAY}.

In certain implementations, the time duration τ_{DELAY} for which the delay circuit 36 delays activating the shut off signal 38 can be a constant duration of time. For example, in certain configurations, the shut off signal 38 can activate when a peak value of the temperature warning signal 34 exceeds a threshold temperature for a certain time period. However, in other configurations, the time duration τ_{DELAY} can change based on a difference between the temperature warning signal 34 and the temperature threshold. For example, when the magnitude of the temperature warning signal 34 is relatively large, the duration of τ_{DELAY} can be relatively short, and when the magnitude of the temperature warning signal 34 is relatively small, the time duration τ_{DELAY} can be relatively long.

The threshold temperature and/or time during for which the delay circuit 36 is configured to delay activating the shut off signal 38 can depend on a variety of factors, such as a processing technology and/or a type of primary circuit to be protected. In one embodiment, the threshold temperature is selected to be between about 250 K and about 430 K. In one embodiment, the time duration τ_{DELAY} is selected to be in the range of about 0.1 microseconds to about 10 microseconds. Although various threshold temperature ranges and time duration ranges have been provided, other values are possible. In one embodiment, the time duration τ_{DELAY} and/or the threshold temperature is programmable.

With continuing reference to FIG. 2, in some embodiments, the thermal protection circuit region 30 additionally includes a hysteresis circuit 44 electrically connected in an electrical path between the time delay circuit 36 and the temperature sensing circuit 32. The hysteresis circuit 44 can aid in preventing rapid thermal oscillation. When present, the hysteresis circuit can be connected to the temperature sensing circuit 32 such that when the shut off signal 38 is activated, a hysteresis signal is transmitted to the temperature sensing circuit 32 that results in a reduction of the threshold temperature at which the temperature warning signal 34 becomes activated. In the illustrated configuration, hysteresis is provided based on the shut off signal 38, rather than based on the temperature warning signal 34. Thus, in the illustrated configuration, hysteresis is provided after the time delay. In the case of a false trigger, configuring the protection circuit in this manner can help prevent the hysteresis from extending the duration of the false triggering event.

In one embodiment, the hysteresis circuit 44 decreases the threshold temperature by less than about 20 K when the temperature warning signal 34 becomes activated. However, other configurations are possible.

FIG. 3 is a schematic cross-sectional view of a thermal overload-protected integrated circuit 10a comprising a thermal protection circuit according to one embodiment. Similar to FIG. 1, but in a cross sectional view, the thermal overload-protected integrated circuit 10a includes a substrate. In the illustrated embodiment, the substrate is a silicon-on-insulator (SOI) substrate on which a primary circuit region 20a and a thermal protection circuit region 30a are monolithically integrated.

The SOI substrate includes a support layer 50, a buried oxide film (BOX) 52 disposed on the support layer 50, and an SOI layer 54 disposed on the BOX 52. The SOI layer 54 can comprise silicon, or can comprise silicon alloyed with other elements such as Ge, C, and Sn and can be doped n-type or p-type. The BOX 52 can comprise any suitable insulator to provide sufficient electrical isolation between the SOI layer 54 and the support layer 50, such as silicon oxide or sapphire. The support layer 50 can comprise silicon or any suitable material to provide support to the BOX 52 and the SOI layer 54. The integrated circuit 10a further includes an n-type epitaxial region 47 formed on the p-type SOI layer 54, a heavily p-doped (p⁺) epitaxial regions 48 disposed adjacent the n-type epitaxial region 47, a p-doped region 46a formed in the n-type epitaxial region 47, a heavily p-doped (p⁺) region 46b formed in the p-doped region 46a, a first heavily n-doped (n⁺) region 46c formed in the p-doped region 46a, and a second heavily n-doped (n⁺) region 46d formed in the n-type epitaxial region 47. For clarity, metallization such as contacts, vias, and wires has been omitted from FIG. 3.

In the illustrated configuration, the integrated circuit 10a includes the primary circuit region 20a and the thermal protection circuit region 30a, which are separated by a trench region 58. The trench region 58 can include, for example, shallow trench isolation (STI) or locally oxidized silicon (LOCOS). The primary circuit region 20a includes a primary circuit 22a, which can comprise, for example, an amplifier 23.

The integrated circuit 10a further includes a temperature sensing circuit that includes a BJT 46 implemented as a vertical N⁺PN bipolar transistor in the thermal protection circuit region 30a. The first n⁺ region 46c, the p-doped region 46a, and the n-type epitaxial region 47 are configured as an emitter, a base, and a collector, respectively, of the BJT 46.

In operation, the BJT 46 can sense a temperature of the thermal protection circuit region 30a, which may change upon receiving heat 24 generated by Joule heating of the primary circuit 22a. Upon sensing a temperature exceeding a threshold temperature level, the temperature sensing circuit including the BJT 46 is configured to activate a temperature warning signal.

FIG. 3 illustrates one example of a configuration in which a heat pulse can reach an integrated temperature sensor relatively quickly and lead to false thermal overload triggering absent use of a time-delay. However, other configurations are possible. For example, the teachings herein are applicable to non-SOI configurations, to other configurations of SOI substrates, and/or to other configurations of temperature sensors and primary circuits.

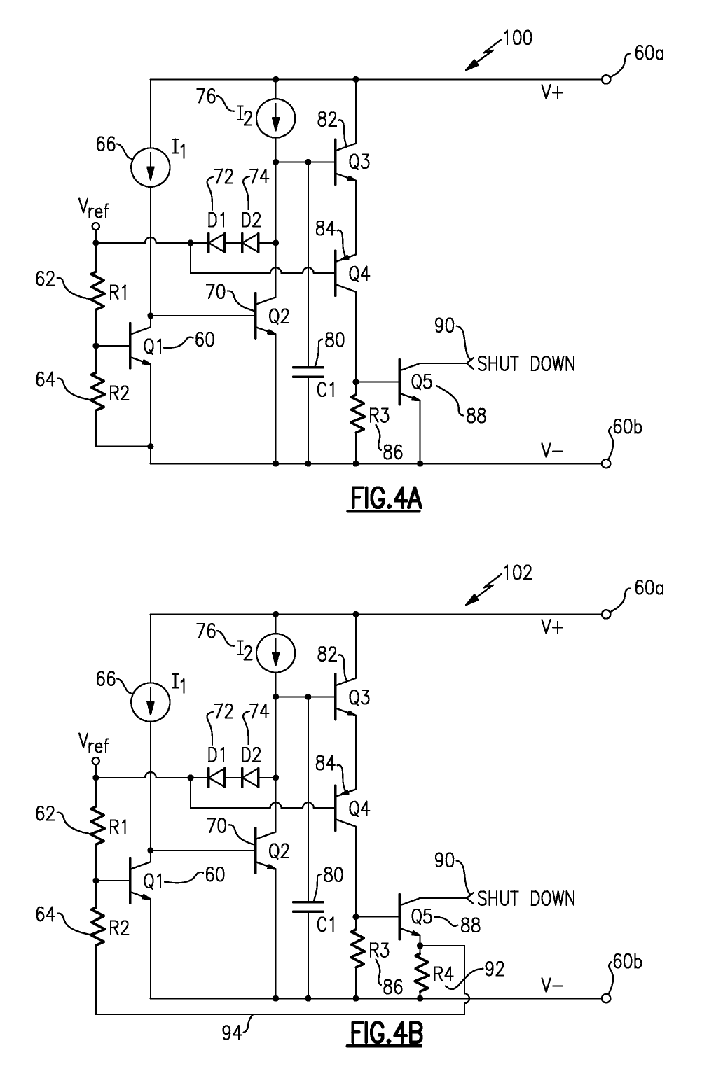

FIG. 4A is a circuit diagram of a thermal overload protection circuit 100 according to one embodiment. The thermal protection circuit 100 includes a first bipolar junction (BJT) transistor (Q₁) 60. The thermal protection circuit 100 comprises a positive or power high supply terminal (V⁺) 60a and a negative or power low supply terminal (V⁻) 60b. The first BJT (Q₁) 60 is a temperature sensing NPN BJT comprising an emitter electrically connected to the negative supply terminal (V⁻) 60b and a base electrically connected to the negative supply terminal (V⁻) 60b through a second resistor (R₂) 64, which has a second resistance value. The base of the first BJT (Q₁) 60 is additionally connected to a reference voltage source V_{REF} through a first resistor (R₁) 62 having a first resistance value. The collector of the first BJT (Q₁) 60 is electrically connected to a first current source (I₁) 66 and further electrically connected to a base of a second bipolar junction transistor (Q₂) 70.

The second BJT (Q₂) 70 is an NPN BJT comprising an emitter connected to the negative supply terminal (V⁻) 60b. The second BJT Q₂ 70 additionally includes a collector connected to a second current source (I₂) 76. The collector of the second BJT (Q₂) 70 is further connected to a first end of the capacitor (C₁) 80 and to an anode of a first diode (D₁) 72, and to a base of a third bipolar junction transistor (Q₃) 82. The capacitor (C₁) 80 further includes a second end electrically connected to the negative supply terminal (V⁻) 60b.

The first diode (D₁) 72 and the second (D₂) diode 74 are electrically connected in series such that a cathode and an anode of the first diode (D₁) 72 are electrically connected to the reference voltage source V_{REF} and a cathode of the second diode (D₂) 74, respectively, and such that a cathode and an anode of the second diode (D₂) 72 are electrically connected to the anode of the first diode (D₁) 72 and the collector of the second BJT (Q₂) 70, respectively.

The third BJT (Q₃) 82 is an NPN BJT comprising an emitter electrically connected to an emitter of a fourth bipolar junction transistor (Q₄) 84. The third BJT (Q₃) 82 additionally includes a base connected to the second current source (I₂) 76, the collector of the second BJT (Q₂) 70, and the capacitor (C₁) 80. The base of the third BJT (Q₃) 82 is further connected to the anode of the second diode (D₂) 74. The third BJT (Q₃) 82 additionally includes a collector connected to the positive supply terminal (V⁺) 60a. The fourth BJT (Q₄) 84 is a PNP BJT comprising an emitter connected to the emitter of the third BJT (Q₃) 82. The fourth BJT (Q₄) 84 additionally includes a base connected to the reference voltage source V_{REF} and the cathode of the first diode (D₁) 72. The fourth BJT (Q₄) additionally includes a collector connected to the negative supply terminal (V⁻) 60b through a third resistor (R₃) 86 having a third resistance value. The collector of the fourth BJT (Q₄) 84 is further connected to a base of a fifth bipolar junction transistor (Q₅) 88.

The fifth BJT (Q₅) 88 is an NPN BJT comprising an emitter connected to the negative supply terminal (V⁻) 60b and the base electrically connected to the collector of the fourth BJT (Q₄) 84 and the third resistor (R₃) 86. The fifth BJT (Q₅) 88 additionally includes a collector electrically connected to a shut-down terminal 90, and the collector of the fifth BJT (Q₅) 88 can be used to generate a shut off signal, such as the shut off signal 38 shown in FIG. 1.

In operation according to one embodiment, the first BJT (Q₁) 60 is configured to sense a temperature that may change in response to heat transmitted by the primary circuit. The base of the first BJT (Q₁) 60 is configured to be biased at V_{REF}*R₁/(R₁+R₂), where R₁ and R₂ are first and second resistances of the first and second resistors 62 and 64, respectively. The first and second resistors 62 and 64 and the first BJT (Q₁) 60 are configured such that at a temperature below a threshold temperature, the first BJT (Q₁) 60 has a relatively small collector current that is smaller than the current generated by the first current source (I₁) 66. In response to the temperature exceeding the threshold temperature, the first BJT (Q₁) 60 is configured to be switched on such that the first BJT (Q₁) 60 has a collector current greater than the current generated by the first current source (I₁) 66.

In response to an increase in temperature exceeding the threshold temperature, the first BJT (Q₁) 60 can turn on and sink the current of the first current source (I₁) 66, and the second BJT (Q₂) 70 can turn off. Thereafter, the thermal protection circuit 100 can operate in a thermal warning mode In which a current of the second current source (I₂) 76 can charge the capacitor (C₁) 80. After a time delay associated with charging the capacitor (C₁) 80, the thermal protection circuit 100 can activate the shut-down signal.

However, as described above, in various embodiments, upon the thermal protection circuit 100 entering the thermal warning mode, a shut-down signal is not activated immediately to disable the primary circuit. Instead, the thermal protection circuit 100 is configured to delay the activation of the shut-down signal.

In one embodiment, the capacitor (C₁) 80 is configured to charge upon the thermal protection circuit 100 entering the thermal warning mode. As the capacitor 80 charges during the thermal warning mode, the voltage across the capacitor 80 rises, which in turn raises the base voltage of the third BJT (Q₃) 82. When the base of the third BJT (Q₃) 82 increases to a sufficient voltage, the third BJT (Q₃) 82 is switched on, which in turn results in switching on of the fourth BJT (Q₄) 84 and the fifth BJT (Q₅) 88, which initiates the activation of a shut-down signal. In one embodiment, the time it takes for the base voltage of the third BJT (Q3) 82 to rise to a sufficient level for activation of the shut-down signal, t_{C}, can be expressed as approximately:

$${t}_{C} = \frac{{C}_{1}}{{I}_{C 1}} [ {V}_{REF} + {V}_{D 1} + {V}_{D 2} ] , \qquad [ 4 ]$$

where V_{REF} is the reference voltage, V_{D1} is a first forward diode voltage of the first diode 72, V_{D2} is a second forward diode voltage of the second diode 74, C₁ is the capacitance value of the capacitor 80, and I_{C1} is the current of the second current source (I₂) 76.

Thus, by configuring the amount of current flowing into the capacitor 80 and the value of the capacitance of the capacitor 80, the thermal protection circuit 100 can be configured to have a delay time proportional to t_{C}, before activating the shut-down signal to initiate a shut-down of the primary circuit. In one embodiment, the values of C₁, I_{C1}, V_{REF}, V_{D1}, and V_{D2} are selected such that t_{C} has a value between about 0.1 microseconds and about 10 microseconds. Upon switching on of the fifth BJT (Q₅) 88, a shut-down signal is activated at the shutdown terminal 90.

Although FIG. 4A has illustrated one example of a thermal overload protection circuit suitable for providing time-delayed thermal overload protection, the teachings herein are applicable to a wide variety of thermal overload protection circuits. Accordingly, other embodiments of thermal overload protection circuits are possible. For example, in one embodiment, the collector current of a BJT is provided to an analog-to-digital converter, which converts the collector current to a digital collector current that is processed using digital thermal overload protection circuitry implemented in accordance with the teachings herein.

FIG. 4B is a circuit diagram of a thermal overload protection circuit according to another embodiment. The circuit elements of the thermal overload protection circuit 102 of FIG. 4B is the same as the thermal overload protection circuit 100 of FIG. 4A, except that the circuit 102 of FIG. 4B additionally includes a fourth resistor 92 having a fourth resistance R₄ connected between the emitter of the fifth BJT (Q₅) 88 and the negative supply terminal (V⁻) 60b. Furthermore, the emitter of the fifth BJT (Q₅) 88 is further connected to the second resistor (R2) 64 though a hysteresis circuit path 94.

In operation, the thermal overload protection circuit 102 of FIG. 4B operates in a similar manner as described above in connection with the thermal overload protection circuit 100 of FIG. 4A, except that after the circuit 102 enters the thermal warning mode and the third BJT (Q₃) 82, the fourth BJT (Q₄) 84 and the fifth BJT (Q₅) 88 are switched on, the hysteresis circuit path 94 provides an additional hysteresis voltage to the base of the first BJT (Q₁) 60, which may be proportional to an IR drop across the fourth resistor (R₄) 92. As a result, the thermally triggered first BJT (Q₁) 60 can tend to remain switched on even when a subsequent voltage of the base of the first BJT (Q₁) 60 falls below the initial value that triggered the first BJT (Q₁) 60.

For example, once triggered, even when the temperature of the first BJT (Q₁) 60 falls below the threshold temperature, such that the base voltage of the first BJT (Q₁) 60 of V_{REF}*R₁/(R₁+R₂) falls below the V_{BE} at which the first BJT (Q₁) 60 is configured to be switched on, the first BJT (Q₁) 60 can remain switched on. In some embodiments, the hysteresis voltage can be configured to depend on the magnitude of the IR voltage drop across the fourth resistor (R₄) 92.

The foregoing description and claims may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the figures depict example arrangements of elements and components, additional intervening elements, devices, features, or components may be present in an actual embodiment (assuming that the functionality of the depicted circuits is not adversely affected).

Although this invention has been described in terms of certain embodiments, other embodiments that are apparent to those of ordinary skill in the art, including embodiments that do not provide all of the features and advantages set forth herein, are also within the scope of this invention. Moreover, the various embodiments described above can be combined to provide further embodiments. In addition, certain features shown in the context of one embodiment can be incorporated into other embodiments as well. Accordingly, the scope of the present invention is defined only by reference to the appended claims.

What is claimed is:

1. A monolithically integrated circuit comprising:
a substrate;
a primary circuit disposed in a primary circuit region on the substrate;
a thermal protection circuit disposed in a thermal protection circuit region on the substrate,
wherein the primary circuit and the thermal protection circuit are in thermal communication, and
wherein the thermal protection circuit comprises:
a temperature sensing circuit configured to sense a temperature of the thermal protection circuit region and to activate a temperature warning signal when the temperature exceeds a temperature threshold level; and
a time delay circuit configured to activate a shut off signal to disable at least a portion of the primary circuit when the temperature warning signal is active for a duration exceeding a time delay.

2. The integrated circuit of claim 1,
wherein the substrate comprises:
a support layer;
a buried oxide layer formed on the support layer; and
a silicon-on-insulator (SOT) formed on the buried oxide layer,
wherein the primary circuit is formed in a primary circuit region disposed in the SOI,
wherein the thermal protection circuit is formed in a protection circuit region disposed in the SOI, and
wherein the primary circuit region and the thermal protection circuit is interposed by a dielectric isolation.

3. The integrated circuit of claim 2, wherein the primary circuit comprises an amplifier.

4. The integrated circuit of claim 3, wherein the temperature sensing circuit comprises a temperature sensing device, the temperature sensing device comprising:
a first N⁺PN bipolar transistor comprising an n-doped region formed in the protection circuit region, a p-doped region formed in the n-doped region, and a heavily n-doped region formed in the n-doped region, such that the heavily n-doped region, the p-doped region, and the n-doped region are configured as an emitter, a base, and a collector of the first N⁺PN bipolar transistor, the a first N⁺PN bipolar transistor configured to flow a collector current that changes in relation to the temperature.

5. The integrated circuit of claim 1, wherein the time delay of the time delay circuit is in the range of about 0.1 microseconds to about 10 microseconds.

6. The integrated circuit of claim 5, wherein the temperature threshold level is between about 250 K and 430 K.

7. The integrated circuit of claim 1, further comprising a feedback circuit configured to provide a hysteresis in the temperature threshold level for activating the temperature warning signal.

8. The integrated circuit of claim 7, wherein the hysteresis is provided after the temperature warning signal is active for the duration exceeding the time delay.

9. The integrated circuit of claim 8, wherein the feedback circuit is configured to decrease the temperature threshold level by less than about 20 K.

10. The integrated circuit of claim 1, wherein the primary circuit region is separated from the thermal protection circuit region by a distance in the range of about 1 μm and about 500 μm

11. A method of protecting a monolithically integrated circuit from thermal overload, the method comprising:
sensing a temperature of a thermal protection circuit region using a sensing circuit disposed in the thermal protection circuit region;
activating a temperature warning signal using the sensing circuit when the temperature exceeds a temperature threshold level;
activating a shut off signal using a time delay circuit in response to the temperature warning signal being active for a duration exceeding a time delay; and
disabling at least a portion of a primary circuit disposed in a primary circuit region in response to activation of the shut off signal.

12. The method of claim 11, further comprising:
activating the primary circuit prior to sensing the temperature; and
sensing the temperature that has increased from an initial temperature level due to heat transferred from the primary circuit region.

13. The method of claim 12,
wherein the primary circuit region and the thermal protection circuit region are formed on a substrate comprising a silicon support layer, the substrate comprising a silicon-on-insulator (SOI) and a buried oxide layer interposing the support layer and the SOT.

14. The method of claim 13, wherein activating the primary circuit comprises activating an amplifier.

15. The method of claim 14, wherein sensing the temperature comprises activating a temperature sensing device, the temperature sensing device comprising:
a first N⁺PN bipolar transistor comprising an n-doped region formed in the protection circuit region, a p-doped region formed in the n-doped region, and a heavily n-doped region formed in the n-doped region, such that the heavily n-doped region, the p-doped region, and the n-doped region are configured as an emitter, a base, and a collector of a first N⁺PN bipolar transistor, the a first N⁺PN bipolar transistor configured to flow a collector current proportional to the temperature.

16. The method of claim 11, wherein the time delay is in the range of about 0.1 microseconds to about 10 microseconds.

17. The method of claim 16, wherein the temperature threshold level is between about 250 K and 430 K.

18. The method of claim 11, further comprising providing a hysteresis in the temperature threshold level for activating the temperature warning signal.

19. The method of claim 18, wherein providing the hysteresis comprises providing hysteresis after the temperature warning signal is active for the duration exceeding the time delay.

20. The method of claim 19 wherein providing the hysteresis further comprises decreasing the temperature threshold level by less than about 20 K in response to activation of the shutoff signal.
